(19) United States
(12) Patent Application Publication
(10) Pub. No.: US 2018/0374065 A1
(43) Pub. Date: Dec. 27, 2018

(54) RESOURCE DISTRIBUTION CHANNEL AUTHORIZATION THROUGH THIRD PARTY SYSTEM INTEGRATION

(71) Applicant: BANK OF AMERICA CORPORATION, Charlotte, NC (US)

(72) Inventors: Jon Robert Wolf, Charlotte, NC (US); Charles R. Liu, San Francisco, CA (US); Matthew Edward Williams, Frisco, TX (US); Jill A. Hatfield, North Easton, MA (US)

(21) Appl. No.: 15/632,731

(22) Filed: Jun. 26, 2017

(51) Int. Cl. G06Q 20/08; G06Q 20/10

(52) U.S. Cl. CPC G06Q 20/0855; G07G 1/14; G06Q 20/102

(57) ABSTRACT

Embodiments of the invention are directed to systems, methods, and computer program products for integration into a third party computer terminal and configure the terminal for facilitating odd denominational resource distribution parameters. As such, the system allows for user access and request of denominations of resources at a third party machine without alternative interaction with the third party machine. The invention may integrate into a third party computer terminal and provide direct communicable linkage channel for odd denominational resource distribution between a user device, third party computer terminal, and a resource distribution platform.

### BACKGROUND

Computer terminals are commonly used by individuals to perform a variety of activities. A needs exists for improved computer terminals at user facing entity locations with enhanced communication and interaction capabilities for user resource distribution.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The system allows a user to access and request denominations of resources at a third party merchant without requiring a purchase at the merchant location. In this way, the system allows for user secure linkage to one or more user accounts when interacting with a merchant computer terminal. As such, the user is able to link to his/her account via a linkage with the merchant third party system in order to perform resource retrieval and distribution including odd denominational resource retrievals that may not be able to be performed at an automated teller machine or the like. Furthermore, the system may parse the user requests for denominations of resources into various envelopes. These envelopes may be digitally associated with the user's account and allow a user to budget or apply resources from the account directly into one or more digital envelopes. For example, the user may allocate resources to these digital envelopes and also withdraw resources directly from the envelopes within a resource distribution account.

Embodiments of the invention relate to systems, methods, and computer program products for channel authorization through third party systems, the invention comprising: integrating within a computer terminal at a third party location associated with the third party system, wherein the computer terminal is capable of a distribution of resources; authorizing a user at the computer terminal and receive a request for resource retrieval at the third party location; generating secure communication linkage for direct linkage to resource distribution account platforms associated with the user authorization for the resource retrieval; receiving user request for a denominational resource retrieval from the computer terminal at the third party location; processing the request for the denominational resource retrieval by allowing third party location distribution of resources equal to the request to the user; and channeling the resources of the request from the resource distribution account platform via the secure communication linkage.

In some embodiments, receiving the user request for denomination resource retrieval from the computer terminal at the third party location further comprises receiving an account and an envelope associated with the account for denominational extraction for the denomination retrieval.

In some embodiments, generating the secure communication linkage for direct linkage to resource distribution account platforms associated with the user authorization further comprises generating a secure linkage between a user device, a point of transaction device, and the resource distribution account platform.

In some embodiments, the computer terminal at the third party location further comprises a point of transaction device at a merchant used for completing a transaction with a merchant.

In some embodiments, resources of the request for denomination resource retrieval are from a user associated account with the resource distribution account platform.

In some embodiments, the request for denomination retrieval request includes an odd denomination amount from a user account.

In some embodiments, authorizing the user at the computer terminal further comprises authorization via user device interaction with the computer terminal via token exchange authorization and passcode acceptance.

In some embodiments, the secure communication linkage further comprises allowing the user to generate and deploy one or more digital envelopes within an account associated with the user at the resource distribution account platforms accessed via the authorization.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, where:

FIG. 1 illustrates a third party resource distribution channel authorization system environment, in accordance with embodiments of the present invention;

FIG. 2 illustrates a representative illustration of a computer terminal associated with the third party resource distribution channel authorization system environment, in accordance with embodiments of the present invention;

FIG. 3 illustrates a block diagram of the processing system associated with the third party resource distribution channel authorization system environment, in accordance with embodiments of the present invention;

FIG. 4 illustrates a block diagram of the user device associated with the third party resource distribution channel authorization system environment, in accordance with embodiments of the present invention;

FIG. 5 illustrates a process flow for setting up the third party system integrated resource distribution channel, in accordance with embodiments of the present invention; and

FIG. 6 illustrates a process of resource distribution using the third party system integrated resource distribution channel, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “transaction” or “resource distribution” refers to any communication between a user and the financial institution or other entity monitoring the user's activities to transfer funds for the purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

In some embodiments, an “entity” may be a financial institution or third party merchant. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In still other embodiments, the entity may be the merchant itself.

In some embodiments, an ATM is operated in a public place (e.g., on a street corner, at the doorstep of a private residence, in an open market, at a public rest stop, or the like). In other embodiments, the ATM is additionally or alternatively operated in a place of business (e.g., in a retail store, post office, banking center, grocery store, factory floor, or the like). In accordance with some embodiments, the ATM is owned by the financial institution providing the ATM. In other embodiments, the ATM is owned by one or more third party merchants. In yet other embodiments, the ATM is owned by other financial institutions. While multiple ATM machines are mentioned throughout this discloser, one of ordinary skill in the art will appreciate that one ATM may include all of the features disclosed herein.

As described herein, a “user” is an individual associated with an entity. As such, in some embodiments, the user may be an individual having past relationships, current relationships or potential future relationships with an entity. In some instances, a “user” is an individual who has a relationship with the entity, such as a customer or a prospective customer. In some instances described herein, the user is an individual who seeks to utilize, operate, or perform one or more activities associated with a computer terminal, typically based on successful validation of the user's authentication credentials. In some embodiments, a “user” may be an employee (e.g., a technology operator/technician, an associate, a project manager, an IT specialist, a manager, an administrator, an internal operations analyst, or the like) of the entity or enterprises affiliated with the entity, capable of operating the systems and computer terminals described herein. In other embodiments, a user may be a system or an entity performing one or more tasks described herein.

The term “computer terminal” or “user activity terminal” as used herein may refer to one or more electronic devices that are associated with a third party merchant or vendor. These computer terminals may be one or more point of transaction terminals, point of sale terminals, or the like that facilitate one or more user activities or transactions with the third party. As such, the terms “user activity” or “user transaction” or simply “activity” may refer to financial or non-financial activities, tasks, events or actions. In some embodiments a computer terminal refers to one or more devices that facilitate execution of financial transactions or activities. In this regard, the computer terminals may be point of sale (POS) devices, vending machines, checkout registers, ticket vending machines, automated retail transaction devices, or may comprise technology elements and/or functionality of one or more aforementioned devices, or a suitable combination of the aforementioned devices/apparatuses. In some embodiments the computer terminal refers to devices that facilitate execution of non-financial user activities or transactions, for example, check-in terminals for various industries, for example: hospitality, travel, healthcare and the like, information kiosks and other computer terminals that do not involve a user performing a financial transaction via the computer terminal. In some embodiments the computer terminals enable execution of both financial and non-financial transactions/activities (e.g., a computer terminal may be a suitable combination of any of the aforementioned terminal devices with respect to their features, design and/or function). That said, computer terminals may also refer to portable devices that facilitate financial and/or non-financial transactions, such as personal computers, laptop computers, tablet computers, smartphones, wearable devices, personal digital assistants (PDAs), and other computing devices. In some embodiments, the computer terminals may be owned, operated and/or otherwise associated entities and are installed at suitable locations, such that the user can travel to the location of the computer terminal to perform user activities or execute transactions. In some embodiments, the computer terminals may be owned, operated and/or otherwise associated with the user. In embodiments described herein, performing a user activity or transaction may refer to the initiation, stages during the processing, or completion of a transaction. The computer terminal of the present invention is interactive and is configured to communicate with a user using visual, audio or other means, either directly (e.g., using display devices of the computer terminal) or via suitable devices (e.g., via a user mobile device).

The system allows a user to access and request denominations of resources at a third party merchant without requiring a purchase at the merchant location. In this way, the system allows for user secure linkage to one or more user accounts when interacting with a merchant computer terminal. As such, the user is able to link to his/her account via a linkage with the merchant third party system in order to perform resource retrieval and distribution including odd denominational resource retrievals that may not be able to be performed at an automated teller machine or the like. Furthermore, the system may parse the user requests for denominations of resources into various envelopes. These envelopes may be digitally associated with the user's account and allow a user to budget or apply resources from the account directly into one or more digital envelopes. For example, the user may allocate resources to these digital envelopes and also withdraw resources directly from the envelopes within a resource distribution account.

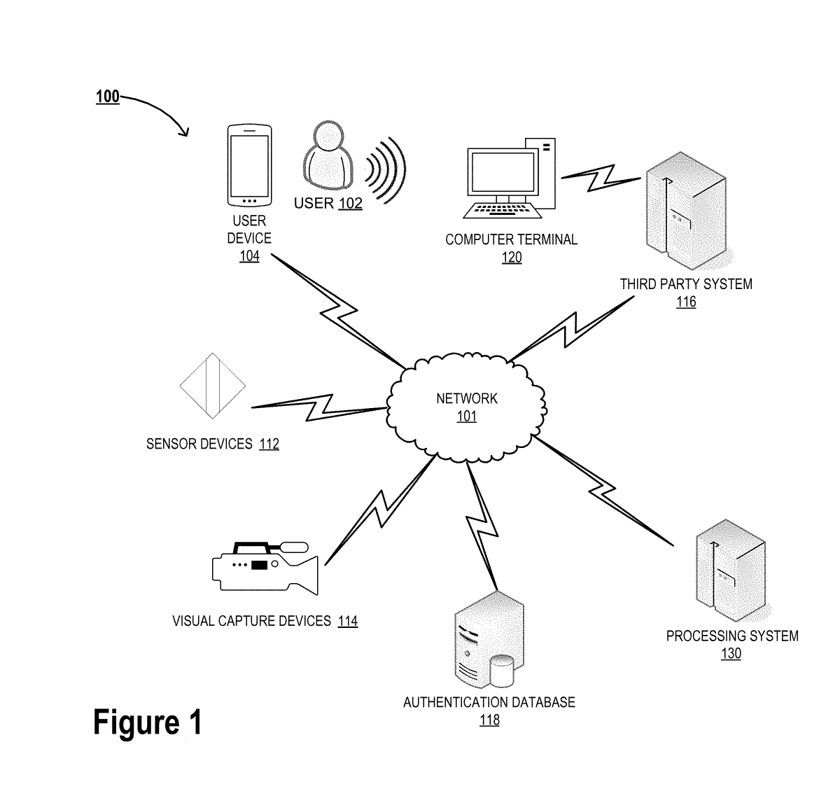

FIG. 1 illustrates a third party resource distribution channel authorization system environment 100, in accordance with embodiments of the invention. As illustrated, the system environment 100 may comprise a computer terminal 120 (also referred to as a point of sale device or point of transaction device, in operative communication with one or more third party systems 116 and is associated with the third party system 116. The system environment also includes a user 102, a processing system 130, one or more sensor devices 112, one or more visual capture devices 114, an authentication database 118, and/or other systems/devices not illustrated herein and connected via a network 101. As such, the computer terminal 120 is configured such that the user 102 may link to the computer terminal 120 to perform one or more user activities or transactions by utilizing the computer terminal directly (for example, by physically operating the computer terminal 120 and its interfaces, using input/output devices of the terminal 120, using audio commands, using physical gestures, and the like) and/or via communication between the user device 104 and the terminal 120 (for example, by establishing operative communication channels between the user device 104 and the terminal 120 via a wireless network and interacting with the terminal 120 via the devices and interfaces of the user device 104).

Typically, the processing system 130 and the authentication database 118 are in electronic communication with the third party system 116, via the network 101, which may be the internet, an intranet or the like. In FIG. 1, the network 101 may include a local area network (LAN), a wide area network (WAN), a global area network (GAN), and/or near field communication (NFC) network. The network 101 may provide for wireline, wireless, or a combination of wireline and wireless communication between devices in the network. In some embodiments, the network 101 includes the Internet. In some embodiments, the network 101 may include a wireless telephone network. Furthermore, the network 101 may comprise wireless communication networks to establish wireless communication channels such as a contactless communication channel and a near field communication (NFC) channel (for example, in the instances where communication channels are established between the user device 104 and the computer terminal 120). In this regard, the wireless communication channel may further comprise near field communication (NFC), communication via radio waves, communication through the internet, communication via electromagnetic waves and the like.

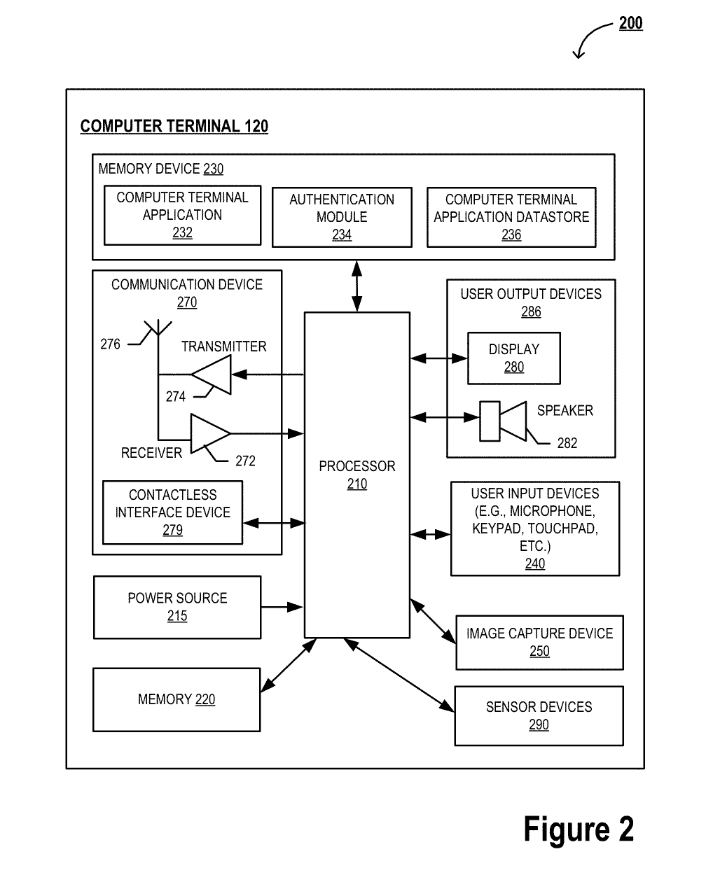

As discussed previously, the computer terminal 120 is configured to facilitate performance of user activities. In some embodiments, the computer terminal 120 is a point of transaction device associated with a merchant configured for uniquely facilitating user activities in accordance with some embodiments, while ensuring the security and privacy of the user. The components of the computer terminal 120, its features and functions will be described in detail through this disclosure and with respect to FIG. 2.

In some embodiments, the computer terminal via the third party system 116 receives signals, images and other data captured by the sensor devices 112 and/or the visual capture devices 114, during its execution of user activities. In this regard, in some embodiments, the third party system 116 communicates with, transmits instructions, and/or receives signals from the sensor devices 112 and the visual capture devices 114 directly, via the network 101, typically, in real-time. In some embodiments, the third party system 116 communicates with the sensor devices 112 and the visual capture devices 114 through the processing system 130, typically, in real-time. Analyzing the signals received from the sensor devices 112 and the visual capture devices 114 typically enables the third party system 116, computer terminal 120, the processing system 130, or the devices 112 and 114 themselves, to determine user location, determine trigger events (e.g., user approach to the terminal 120, retrieve/identify user authentication credentials from the user and/or the user device, establishing communication with the user device in the vicinity of the terminal, determination of whether the user device comprises an integrated resource transfer application, and the like), capture one or more parameters associated with the environment or physical location of the computer terminal 120, and the like.

In some embodiments, the sensor devices 112 are position sensors configured to sense or determine the position and/or location of the user 102, other individuals, objects/devices, or entities. As such, the sensor devices 112 may determine an absolute positon (for example, location/positioning coordinates) or a relative position (for example, with respect to the position of the terminal 120, with respect to position of the user or another individual, with respect to the sensor 112 itself or a predetermined object and the like) of the user, individual or object. Here, in some embodiments, the sensor devices 112 are proximity sensors that are configured to determine the presence of the user or object within a predetermined proximity area. These sensor devices 112 may be contact type sensors that determine the presence of the user or object based on contact, or non-contact type sensors that detect distant users or objects. Typically, the sensor devices 112 comprise a first transducer that is configured to convert electrical energy into a proximity signal (for example, an electromagnetic wave, a sound wave, and the like) that is broadcast in a predetermined proximity area. The incidence of the proximity signal on physical users or objects within the proximity area results in a return signal/wave that is captured by the sensor 112. The return signal/wave is then converted to an electric signal by a second transducer of the sensor. This electric signal may be analyzed, in real-time, by the sensor 112, the terminal 120, and/or the processing system 130, to determine the location of the user/object and/or track movement of the user/object. Here, the sensor 112 may be configured to perform modulation, demodulation, amplification and output switching of the proximity and return signals.

For example, in some embodiments, the sensor devices 112 comprise ultrasonic sensors that are configured to transmit a proximity signal comprising sound waves (typically with frequencies above 18 kHz) and are further configured to receive a return signal in the form or an echo, which is then converted to an electric signal for analysis. As another example, in some embodiments, the sensor devices 112 comprise optical sensors or photoelectric sensors that are configured to transmit a proximity signal comprising electromagnetic waves, and specifically light waves (for example, infrared waves with frequencies in the range of about 600 GHz to 430 THz, such as pulsed infrared or visible red waves, laser waves in the visible or infrared frequency range, and the like) and are further configured to receive a return signal, either in the form of a reflection signal or interruption of the light proximity signal at receiver associated with the sensor 112, which is then converted to an electric signal for analysis. As yet another example, the sensor devices 112 comprise inductive proximity sensors and inductive position sensors for determining the presence and positon, respectively, of users and objects, which generate an induction loop to thereby produce a proximity signal in the form or a magnetic field. The presence of users or objects varies the current flowing through the loop which facilitates determination of presence of users or objects. In some embodiments, the sensor devices 112 comprise sensor devices provided in the user device 104, such as, biometric sensors (for example, fingerprint scanner of a mobile phone, heart rate or temperature monitor of a wearable user device, and the like), location sensors (for example, GPS devices, accelerometers, and the like), visual capture devices/cameras, facial recognition devices, devices for capturing user gestures (for example, a touch screen) and other sensing devices of the user device 104. Here, the terminal 120 and/or the processing system 130 may transmit control signals to the user device to cause the sensing devices of the user device 104 to capture one or more parameters and/or to transmit one or more captured parameters.

The visual capture devices 114 typically comprise cameras and other audio, video and image capture devices. These visual capture devices 114 are configured to capture images and/or video streams, typically in real-time, of a predetermined proximity area. The images and/or video streams may be analyzed by the computer terminal 120, the processing system 130 and/or the capture devices 114, to determine the presence and position of the user, other individuals or objects and their movement in the proximity area. Although described separately, it is understood that the visual capture devices 114 may be associated with the sensor devices 112. As such, sensors or sensor devices, as alluded to herein, may refer to the various sensor devices described herein and the visual/image capture devices described herein.

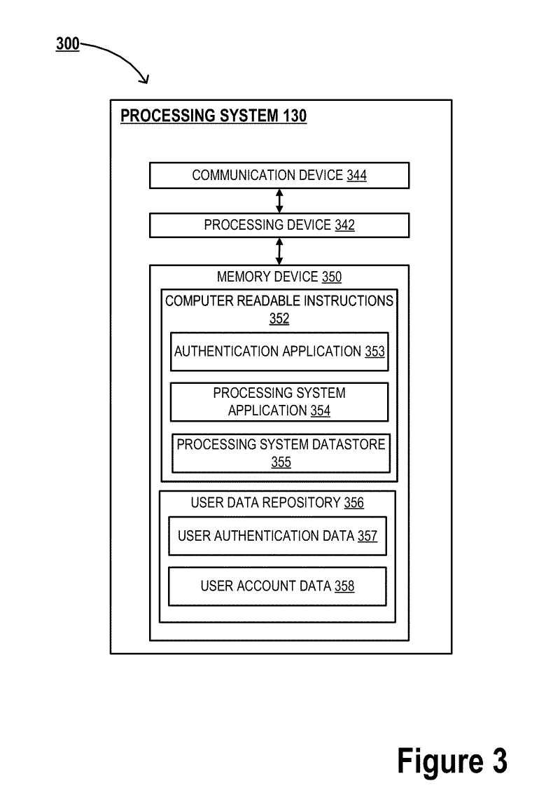

As alluded to previously, the processing system 130 is in operative communication with the computer terminal 120 via linkage through the third party system 116. In some embodiments, processing system 130 is configured to transmit control instructions that are configured to cause the computer terminal 120, the user device 104, the sensor device 112 and/or the visual capture devices 114 to perform at least a portion of the steps associated with one or more activities. The processing system 130 may be associated with the same entity as the computer terminal 120 or may be associated with another entity. The structure and components of the processing system 130 is described in detail with respect to FIG. 3. The authentication database 118 may comprise authentication credentials associated with the user. The processing system 130 and/or the computer terminal 120 may retrieve the authentication credentials from the authentication database to authenticate the user prior to executing one or more user activities or transactions.

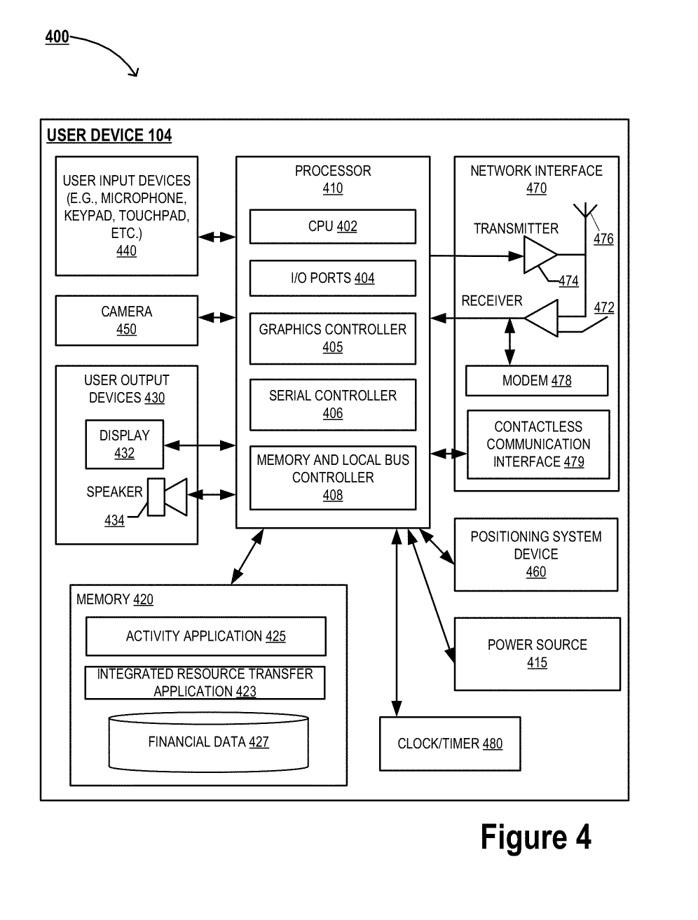

The user device 104 may comprise a mobile communication device, such as a cellular telecommunications device (i.e., a smart phone or mobile phone), a computing device such as a laptop computer, a personal digital assistant (PDA), a mobile internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. As discussed previously, in some embodiments, the computer terminals 120 of the present invention are configured to establish operative communication channels with the user device 104 such that, the user 102 may perform one or more user activities, either entirely or in part, at the terminal 120 by interacting with the user device 104. The user device 104 is described in detail with respect to FIG. 4.

FIG. 2, illustrates a block diagram 200 of the computer terminal 120 associated with third party resource distribution channel authorization system environment, in accordance with some embodiments of the invention. In some embodiments, the computer terminal 120 may be another individual and his/her mobile device. In this way, the individual may have a denomination that the user desires. Upon indication, the individual may be able to provide the user with the denomination he/she requests. As such, as used herein in may be understood that a computer terminal 120, merchant device, or point of transaction device may be another individual and his/her mobile device.

As discussed previously, the computer terminal 120 is, in some embodiments, a point of transaction device or point of sale device and is configured to facilitate performance of user activities, and is configured to provide real-time interactive sessions for the user 102, using one or more communication channels established via the network 101. The computer terminal 120 typically includes a processing device or a processor 210, memory device 230, storage memory 220 or datastore 220, and a communication device 270. As such, the computer terminal 120, and the processor 210 is particular, is configured to perform at least a portion of the steps of the embodiments described herein, either based on executing computer readable instructions stored in the memory device 230, and/or based on receiving instructions, indications, or signals from other systems and devices such as the processing system 130, the user device 104, sensor devices 112, visual capture devices 114, the user 102, and/or other systems. In some embodiments, the processing system 130 is configured to transmit control instructions to, and cause the processing device 210 to perform one or more steps of the embodiments presented herein. For example, the processing system 130 may detect a trigger event and transmit an indication to the processing device 210. In response to receiving the control signal from the system 130, the processing device 210 may initiate a presentation of environment parameters.

The processing device 210 may generally refer to a device or combination of devices having circuitry used for implementing the communication and/or logic functions of the computer terminal 120. For example, the processing device 210 may include a control unit, a digital signal processor device, a microprocessor device, and various analog-to-digital converters, digital-to-analog converters, and other support circuits and/or combinations of the foregoing. Control and signal processing functions of the computer terminal 120 may be allocated between these processing devices according to their respective capabilities.

The computer terminal 120 may further include various components/devices in operative communication with and/or controlled by the processor 210, such as user output devices 286, user input devices 240, a network communication interface 279 (such as a contactless interface 279), a power source 215, and the like. Furthermore, in some embodiments, the processor 210 is operatively coupled to and is configured to control other components/devices of the computer terminal 120, such as an image capture device 250, sensor devices 290, and the like. These components and devices are described in detail below.

The memory device 230 and the storage memory 220 may generally refer to a device or combination of devices that store one or more forms of computer-readable media for storing data and/or computer-executable program code/instructions. In some embodiments, the storage memory 220 is integral with the memory device 230. In some embodiments, the memory device 230 comprises a non-transitory, computer readable storage medium. For example, the memory device 230 and/or the storage memory 220 may include any computer memory that provides an actual or virtual space to temporarily or permanently store data and/or commands provided to the processing device 210 when it carries out its functions described herein.

As illustrated by FIG. 2, the memory device 230 typically comprises a computer terminal application 232 (also referred to as a terminal application), an authentication module 234, a computer terminal application datastore 236 stored therein. In some embodiments, the authentication module 234 is integral with the computer terminal application 232. In some embodiments, the computer terminal applications 232 and/or the authentication module 234 may be executable to initiate, perform, complete, and/or facilitate one or more portions of any embodiment described and/or contemplated herein, either independently or in response to receiving control instructions from the processing system 130. In some embodiments, the computer terminal application/module 232 comprises computer readable instructions stored in the memory device 230, which when executed by the processing device 210, are configured to cause the processing device 210 to perform one or more steps of the embodiments presented herein, and/or cause the processing device to transmit control instructions to other components of the terminal 120 and other devices/systems in the network 101 to cause them to perform the steps. Generally, the computer terminal application 232 is executable to receive activity instructions from the user and perform user activities and the various steps described herein. In some embodiments, the computer terminal application 232 comprises a personal digital assistant for interfacing with the user at the terminal. The computer terminal application 232 may be coupled to a computer terminal application datastore 236 for storing application data as the user activity is being performed. The computer terminal application datastore 236 may store the application data temporarily for the predetermined duration of the execution of the activity (such as a memory buffer, or cache memory), or permanently.

The computer terminal 120 may require users to identify and/or authenticate themselves before the computer terminal 120 may initiate, perform, complete, and/or facilitate a user activity. For example, in some embodiments, the computer terminal 120 is configured (and/or the computer terminal application 232 is executable) to authenticate a computer terminal user based at least partially on a computer terminal debit card, smart card, token (e.g., USB token, etc.), username, password, PIN, biometric information, and/or one or more other credentials that the user presents to the computer terminal 120. Additionally or alternatively, in some embodiments, the computer terminal 120 is configured to authenticate a user by using one-, two-, or multi-factor authentication. For example, in some embodiments, the computer terminal 120 requires two-factor authentication, such that the user must provide a valid debit card and enter the correct PIN associated with the debit card in order to authenticate the user to the computer terminal 120. However, either alternatively or in addition to the aforementioned authentication features, the computer terminal 120 may require biometric authentication of the user 102 before initiating, performing, completing, and/or facilitating a user activity.

In some embodiments, the authentication module 234 comprises computer readable instructions that when executed by the processing device 210 cause the processing device to perform one or more functions and/or transmit control instructions to other components or devices to perform one or more authentication steps described herein. These authentication steps typically include requesting authentication credentials from the user via the user output devices 286 (for example, based on determining the desired authorization level for the user activity), activating pertinent sensors and devices for receipt of the credentials (sensor devices 290/image capture devices 250 for biometric credentials, card reader devices 240 for reading magnetic strips of the user's card(s), contact less interface device 279 for receiving authentication tokens from a user device via NFC channels, and the like), receiving authentication credentials, validating the credentials (for example based on retrieving user credentials from the datastore 236, memory 220, processing system 130 and/or database 118), and the like. That said, as shown, the processing device 210, in turn, is operatively connected to and is also configured to control and cause the communication device 270, the memory device 230, and other components described herein to perform one or more functions, at least in part.

The communication device 270 may comprise a modem 271 (not illustrated), a receiver 272, a server 273 (not illustrated), a transmitter 274, transceiver, and/or another device for communicating with other devices and systems on the network 101. The communication device 270 may further comprise a contact, contactless, wireless and/or wired interface that is configured to establish communication between components of the computer terminal 120, between the computer terminal 120, particularly the processing device 210, and other devices or systems, such as the processing system 130, the user device 104, the authentication database 118, the third party system 116, and the like. In this regard, the communication interface 270 comprises a transmitter 274, a receiver 272, a broadcasting device 276 to transmit and receive signals from corresponding devices via a suitable transmission medium or a communication channel. In some embodiments, the computer terminal 120 is configured to be coupled/connected to other devices and systems via wired communication channels. In other embodiments, the computer terminal 120 is configured to be coupled/connected to other devices via a wireless channel. In this regard, the wireless communication channel may comprise near field communication (NFC), communication via radio waves, communication through the internet, communication via electromagnetic waves and the like. The communication device 270 may further comprise a contactless interface device 279 for establishing contactless communication with other devices, such as the user device 104. Here, the computer terminal 120 may include a transceiver, i.e., one or more antennas and and/or other electronic circuitry, devices, and software, for receiving data when a device is held close to or tapped at a suitable location of the computer terminal 120. Here, radio frequency signals may be transmitted and received in the radio frequency band, such as 13.56 MHz which is generally the frequency for NFC. In one embodiment, the ISO/IEC 14443 standard may define the protocol associated with the data carried by these radio frequency signals. In one embodiment, the transmitter 274 and receiver 272 may transmit and receive radio frequency signals, respectively, from the computer terminal 120 within a distance of up to approximately 25 cm, and from 0-20 cm, such as from 0-15 cm, and 0-10 cm, and the like.

Establishing the communication channels may also include signaling information in accordance with the air interface standard of the applicable cellular system of the wireless telephone network that may be part of the network 101. In this regard, the computer terminal 120 may be configured to operate with one or more air interface standards, communication protocols, modulation types, and access types. By way of illustration, the computer terminal 120 may be configured to operate in accordance with any of a number of first, second, third, and/or fourth-generation communication protocols and/or the like. For example, the computer terminal 120 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The computer terminal 120 may also be configured to operate in accordance with non-cellular communication mechanisms, such as via a wireless local area network (WLAN) or other communication/data networks.

The user interface of the computer terminal 120 may include user input devices 240 and user output devices 286, as illustrated by FIG. 2. The user interface of the computer terminal 120 is typically configured to facilitate the interactive sessions with the user. The user output devices 286 typically include a display 280 (e.g., a liquid crystal display, a touchscreen display, and/or the like) which is operatively coupled to the processing device 210. In some embodiments, where the computer terminal 120 requests the user's signature (if needed), the display may also serve as a touchpad input device to input the user's signature via a stylus. Other output devices may include one or more LEDs or an audio speaker 282, both which may indicate to the user various steps of a user activity. The output devices 286 including the display 280 typically provide instructions and information to the user, regarding the user activity and steps associated with the user activity. The user interface 126 may include any number of user input devices 240 allowing the computer terminal 120 to transmit/receive data to/from the user 102, such as a keypad, keyboard, touch-screen, touchpad, microphone, mouse, joystick, other pointer device, button, soft key, and/or other input device(s). A printer that can print paper receipts may also be incorporated into the computer terminal 120.

As illustrated by FIG. 2, the computer terminal may further comprise an image capture device 250. The image capture device 250 typically comprises cameras and other audio, video and image capture devices. The image capture device 250 is configured to capture images and/or video streams, typically in real-time, of a predetermined proximity area in the vicinity of the computer terminal 120 location. The images and/or video streams may be analyzed by the computer terminal 120 to determine the presence and position of the user, other individuals or objects and their movement in the proximity area, to identify the user for authentication or facial recognition purposes, and the like. In some embodiments, the system is configured to present a customized interface for the user based on identifying the user using facial recognition.

In some embodiments, the computer terminal further comprises sensor devices 290. In some embodiments, the processor 210 communicates with, transmits instructions, and/or receives signals from the sensor devices 290, in real-time for detecting the presence of the users or other individuals, determining user location, capturing authentication credentials for the user, determining parameters associated with the user, determining trigger events, capturing one or more parameters associated with the environment or physical location of the computer terminal 120, and the like. These sensor devices 112 may be contact type sensors that determine the presence of the user or object based on contact, or non-contact type sensors that detect distant users or objects. In some embodiments, the sensor devices 290 of the computer terminal are similar to the sensor devices 112 described previously, for determining the absolute or relative position, location, and proximity of the user, other individuals, or predetermined objects (such as vehicles, and vehicle features like contours of windows), within a predetermined proximity area. For example, the sensor devices 290 may comprise ultrasonic sensors, optical sensors, photoelectric sensors, capacitance sensors, inductive proximity/position sensors, visual capture devices (as described with respect to image/visual capture devices 114 and 250), and the associated transducers, transmitter and modulators, described in detail previously.

In some instances, the sensor devices 290 comprise biometric sensors for capturing parameters associated with the user, such as fingerprint scanners, voice recognition sensors, facial recognition sensors, heart rate sensors, user stress level sensors and the like. These biometric sensors 290 are configured to retrieve, receive, analyze and or validate biometric credentials associated with the user. In this regard, the biometric sensors 290 may comprise optical sensors, ultrasonic sensors, and/or capacitance sensors. The biometric sensors may further comprise radio frequency, thermal, pressure, piezo-resistive/piezoelectric, microelectromechanical sensors, and the like.

In some embodiments, the computer terminal 120 may be associated with the system invention. In some embodiments, the computer terminal 120 may be associated with a third party system. In this way, the processing system 130 may integrate the computer terminal 120 with software and/or hardware for performing the functions described herein.

FIG. 3 illustrates a block diagram of the processing system associated with third party resource distribution channel authorization system environment 300, in accordance with embodiments of the present invention. As illustrated in FIG. 3, the processing system 130 may include a communication device 344, a processing device 342, and a memory device 350 having an authentication application/module 353, a processing system application 354 and a processing system datastore 355 stored therein. As shown, the processing device 342 is operatively connected to and is configured to control and cause the communication device 344, and the memory device 350 to perform one or more functions. Furthermore, the processing device 342 is typically configured to control and cause the processing device 210 of the computer terminal 120, the sensor devices 112, and visual capture devices 114, to perform one or more functions. In some embodiments, the authentication application 353 and/or the processing system application 354 comprises computer readable instructions that when executed by the processing device 342 cause the processing device 342 to perform one or more functions and/or transmit control instructions to the computer terminal 120, the authentication database 118, the third party system 116, the sensor devices 112, and visual capture devices 114, and/or the communication device 344. It will be understood that the authentication application 353 and/or the processing system application 354 may be executable to initiate, perform, complete, and/or facilitate one or more portions of any embodiments described and/or contemplated herein, and specifically embodiments directed to user activities. The authentication application 353 may comprise executable instructions associated with one or more authentication steps of user activities, and may be embodied within the processing system application 354 in some instances. In some embodiments, the authentication application 353 is similar to the authentication module 234 described previously. The processing system 130 may be owned by, operated by and/or affiliated with financial institutions or other entities. Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that may provide payment accounts for transactions. In accordance with embodiments of the invention, the term “financial institution” refers to any organization in the business of moving, investing, or lending money, dealing in financial instruments, or providing financial services. This includes commercial banks, thrifts, federal and state savings banks, savings and loan associations, credit unions, investment companies, merchants, insurance companies and the like. In some embodiments, the computer terminal 120 may be associated with the system invention. In this way, the processing system 130 may integrate the computer terminal 120 with software and/or hardware for performing the functions described herein.

The communication device 344 may generally include a modem, server, transceiver, and/or other devices for communicating with other devices on the network 101. The network communication device 344 may be a communication interface having one or more communication devices configured to communicate with one or more other devices on the network 101, such as the processing system 130, the sensor devices 112, and visual capture devices 114, other processing systems, data systems, etc.

Additionally, referring to processing system 130 illustrated in FIG. 3, the processing device 342 may generally refer to a device or combination of devices having circuitry used for implementing the communication and/or logic functions of the processing system 130. For example, the processing device 342 may include a control unit, a digital signal processor device, a microprocessor device, and various analog-to-digital converters, digital-to-analog converters, and other support circuits and/or combinations of the foregoing. Control and signal processing functions of the system 130 may be allocated between these processing devices according to their respective capabilities. The processing device 342 may further include functionality to operate one or more software programs based on computer-executable program code 352 thereof, which may be stored in a memory device 350, such as the processing system application 354 and the authentication application 353. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 342 may be configured to use the network communication interface of the communication device 344 to transmit and/or receive data and/or commands to and/or from the other devices/systems connected to the network 101.

Furthermore, a “user interface” (not illustrated) may be associated with the processing system 130 and may generally include a plurality of interface devices and/or software that allow a user to input commands and data to direct the processing device to execute instructions. For example, the user interface may include a graphical user interface (GUI) or an interface to input computer-executable instructions that direct the processing device to carry out specific functions. The user interface may employ certain input and output devices to input data received from the user 102 or output data to the user 102. These input and output devices may include a display, mouse, keyboard, button, touchpad, touch screen, microphone, speaker, light, joystick, switch, and/or other customer input/output device for communicating with one or more customers. In some embodiments, the user interface may be provided externally to the processing system, for example on one or more workstations connected to the system 130, the user device 104 or the display device 280 of the computer terminal 120. As another example, the user interface may be provided on the computer terminal 120 that may be controlled by the processing system 130 either directly or via the processing device 210 of the computer terminal 120.

The memory device 350 within the processing system 130 may generally refer to a device or combination of devices that store one or more forms of computer-readable media for storing data and/or computer-executable program code/instructions. For example, the memory device 350 may include any computer memory that provides an actual or virtual space to temporarily or permanently store data and/or commands provided to the processing device 342 when it carries out its functions described herein. The processing system 130 may be used by a third party/entity 116 to interact with the computer terminal 120, based on providing requisite authorization. The processing system 130 may further comprise a user data repository 356 comprising user authentication data 357 and user account data 358. The processing system 130 may utilize the authentication data 357 to validate user authentication credentials. Furthermore, the account data 358 may reflect the current account data of the user.

FIG. 4 illustrates a block diagram of the user device associated with the third party resource distribution channel authorization system environment 400, in accordance with embodiments of the present invention. The user device 104 may include a user mobile device or the like. A “mobile device” 104 may be any mobile communication device, such as a cellular telecommunications device (i.e., a cell phone or mobile phone), personal digital assistant (PDA), a mobile Internet accessing device, or another mobile device including, but not limited to portable digital assistants (PDAs), pagers, mobile televisions, gaming devices, laptop computers, cameras, video recorders, audio/video player, radio, GPS devices, any combination of the aforementioned devices.

The mobile device 104 may generally include a processing device or processor 410 communicably coupled to devices such as, a memory device 420, user output devices 430 (for example, a user display device 432, or a speaker 434), user input devices 440 (such as a microphone, keypad, touchpad, touch screen, and the like), a communication device or network interface device 470, a power source 415, a clock or other timer 480, a visual capture device such as a camera 450, a positioning system device 460, such as a geo-positioning system device like a GPS device, an accelerometer, and the like, one or more chips, and the like. The processor 410 may further include a central processing unit 402, input/output (I/0) port controllers 404, a graphics controller 405, a serial bus controller 406 and a memory and local bus controller 408.

The processor 410 may include functionality to operate one or more software programs or applications, which may be stored in the memory device 420. For example, the processor 410 may be capable of operating applications such as the activity application 425, a integrated resource transfer application 423, or a web browser application. The activity application 425 may then allow the mobile device 104 to transmit and receive data and instructions from the computer terminal 120 (for example, via wireless communication or NFC channels), data and instructions from the processing system 130, web content, such as, for example, location-based content and/or other web page content, according to a Wireless Application Protocol (WAP), Hypertext Transfer Protocol (HTTP), and/or the like.

The integrated resource transfer application 423 and the financial data module 427, together may include the necessary circuitry to provide token storage and transmission functionality, transmitter device signal encoding and decoding functionality to the mobile device 104, for secure transmission of financial and authentication credential tokens via the contactless communication interface 479 to the computer terminal 120. That said, in some embodiments the integrated resource transfer application 423 is pre-installed on the user device 104, while in other embodiments, the terminal 120 may transmit and cause installation of the application 423 based on determining that the user device 104 does not comprise the application 423, when the user device is within a pre-determined distance from the terminal 120.

The processor 410 may be configured to use the network interface device 470 to communicate with one or more other devices on a network 101 such as, but not limited to the computer terminal 120 and the processing system 130. In this regard, the network interface device 470 may include an antenna 476 operatively coupled to a transmitter 474 and a receiver 472 (together a “transceiver”), modem 478 and a contactless communication interface 479. The processor 410 may be configured to provide signals to and receive signals from the transmitter 474 and receiver 472, respectively. The signals may include signaling information in accordance with the air interface standard of the applicable BLE standard, cellular system of the wireless telephone network and the like, that may be part of the network 101. In this regard, the mobile device 104 may be configured to operate with one or more air interface standards, communication protocols, modulation types, and access types. By way of illustration, the mobile device 104 may be configured to operate in accordance with any of a number of first, second, third, and/or fourth-generation communication protocols and/or the like. For example, the mobile device 104 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 104 may also be configured to operate in accordance with non-cellular communication mechanisms, such as via a wireless local area network (WLAN) or other communication/data networks. The mobile device 104 may also be configured to operate in accordance Bluetooth® low energy, audio frequency, ultrasound frequency, or other communication/data networks.

The network interface device 470 or communication device 470 may also include a user activity interface presented in user output devices 430 in order to allow a user 102 to execute some or all of processes described herein. The application interface may have access to the hardware, for example, the transceiver, and software previously described with respect to the network interface device 470. Furthermore, the application interface may have the ability to connect to and communicate with an external data storage on a separate system within the network 101. As described above, the mobile device 104 includes a display device 432 having a user interface that includes user output devices 430 and/or user input devices 440. The user output devices 430 may include a display 432 (e.g., a liquid crystal display (LCD) or the like) and a speaker 434 or other audio device, which are operatively coupled to the processor 410. The user input devices 440, which may allow the mobile device 104 to receive data from the user 102, may include any of a number of devices allowing the mobile device 104 to receive data from a user 102, such as a keypad, keyboard, touch-screen, touchpad, microphone, mouse, joystick, other pointer device, button, soft key, and/or other input device(s).

The mobile device 104 may further include a power source 415. Generally, the power source 415 is a device that supplies electrical energy to an electrical load. In some embodiment, power source 415 may convert a form of energy such as solar energy, chemical energy, mechanical energy, and the like, to electrical energy. Generally, the power source 415 in a mobile device 104 may be a battery, such as a lithium battery, a nickel-metal hydride battery, or the like, that is used for powering various circuits, for example, the transceiver circuit, and other devices that are used to operate the mobile device 104. Alternatively, the power source 415 may be a power adapter that can connect a power supply from a power outlet to the mobile device 104. In such embodiments, a power adapter may be classified as a power source “in” the mobile device 104.

The mobile device 104 may also include a memory buffer, cache memory or temporary memory device operatively coupled to the processor 410. Typically, one or more applications 425 and 423, are loaded into the temporarily memory during use. As used herein, memory may include any computer readable medium configured to store data, code, or other information. The memory device 420 may include volatile memory, such as volatile Random Access Memory (RAM) including a cache area for the temporary storage of data. The memory device 420 may also include non-volatile memory, which can be embedded and/or may be removable. The non-volatile memory may additionally or alternatively include an electrically erasable programmable read-only memory (EEPROM), flash memory or the like.

In some instances, various features and functions of the invention are described herein with respect to a “system.” In some instances, the system may refer to the computer terminal 120 performing one or more steps described herein in conjunction with other devices and systems, either automatically based on executing computer readable instructions of the memory device 230, or in response to receiving control instructions from the processing system 103. In some instances, the system refers to the processing system 103. In some instances, the system refers to the devices and systems on the network environment 100 of FIG. 1. The features and functions of various embodiments of the invention are be described below in further detail.

It is understood that the servers, systems, and devices described herein illustrate one embodiment of the invention. It is further understood that one or more of the servers, systems, and devices can be combined in other embodiments and still function in the same or similar way as the embodiments described herein.

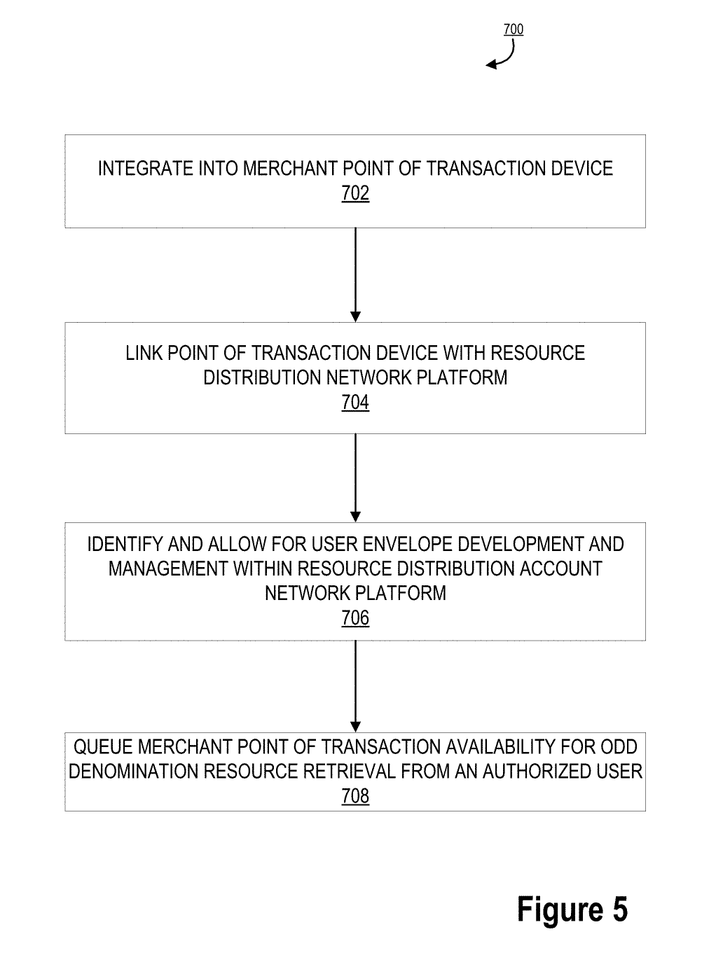

FIG. 5 illustrates a process flow for setting up the third party system integrated resource distribution channel 700, in accordance with embodiments of the present invention. As illustrated in block 702, the process 700 is initiated by integration into a merchant point of transaction device. In this way, the system integrates within a computer terminal, such as a third party point of transaction device or the like providing software and/or hardware for performing the functions of creating a resource distribution channel authorization through the third party system. As such, the system interlinks within a third party point of transaction device for resource distribution channel authorization through the device.

Next, as illustrated in block 704, the process 700 continues to link the point of transaction device with resource distribution network platforms. The resource distribution network platforms may store and manage one or more resource distribution accounts. These accounts may include credit card accounts, savings accounts, checking accounts, or other resource storage account mediums. In some embodiments, resources include denominational currency such as cash or other currency for purchasing goods or services. The linkage is a secure direct linking from the point of transaction device via the merchant system hardwire or wireless connection over a network to one or more resource distribution network platforms. In some embodiments, the system may provide a hub or intermediary for the point of transaction system to route to the appropriate resource distribution network platform based on the user available and authorized accounts. In some embodiments, the point of transaction is a routing device for the user via the user device to communicate with a resource distribution network platform. The point of transaction device may provide authentication of the user and the user device for accessing the resource distribution network platform.

As illustrated in block 706, the process 700 continues by identifying and allowing for user envelope development and management within the resource distribution account network platform. In this way, the user may deploy one or more envelopes within an account at a financial institution or the like. A user may have a savings account at a resource distribution account network financial institution. The user may be able to generate one or more envelopes for budgeting of the funds within the account. For example, the user may have an envelope for entertainment, home improvement, social, groceries, clothing, or the like. The system may automatically deploy a percentage or specific amount of resources into each envelope as determined or requested by the user. As such, the user may also be able to extract resources from one or more envelopes for budgeting, organizing, and reconciliation purposes.

In some embodiments, the system may also provide the user with incentives, such as merchant discounts or the like for using the resource distribution channel authorization through the third party. As such, providing the user with a valued proposition for the extraction of funds from the point of transaction device associated with the merchant.

Next, as illustrated in block 708, the process 700 continues by queuing the merchant point of transaction availability for odd denomination resource retrieval for an authorized user at the merchant point of transaction. In this way, a user may authorize into the resource distribution channel third party system integration network and request funds in the form of any denomination from the point of transaction device. As such, the system allows a user to retrieve odd denominations from the user's accounts at a merchant point of transaction. These odd denominations would be impossible to be retrieved from an ATM or similar device.

An odd denomination resource request is any request for an amount of resources to be cashed at the computer terminal that the computer terminal does not have exact change to cash. For example, if the computer terminal only has $20.00 currency bills and the resource request is no divisible by $20.00 is an odd denomination. As such, an odd denomination is dependent on the variety of currency that the computer terminal has available for distribution. In this way, a typical computer terminal or ATM may be able to dispense funds in denominations divisible by $5.00, $10.00, or $20.00. Standard computer terminals are not capable of dispensing change and/or odd denominations that are not made of up $5.00, $10.00, or $20.00 dollar bills. For example, a standard computer terminal cannot provide a user with $8.25 as it does not have the required currency to be able to distribute exact change to the user. This system allows a third party point of transaction device to be a resource distribution device for the user to retrieve odd denominations directly from his/her account while the merchant would be provided the resource amount from the user account upon distribution of the resources to the user.

In some embodiments, the merchant may be another individual. In this way, the individual may have a denomination that the user desires. Upon indication, the individual may be able to provide the user with the denomination he/she requests. As such, as used herein in may be understood that a merchant or point of transaction may be another individual and his/her mobile device.

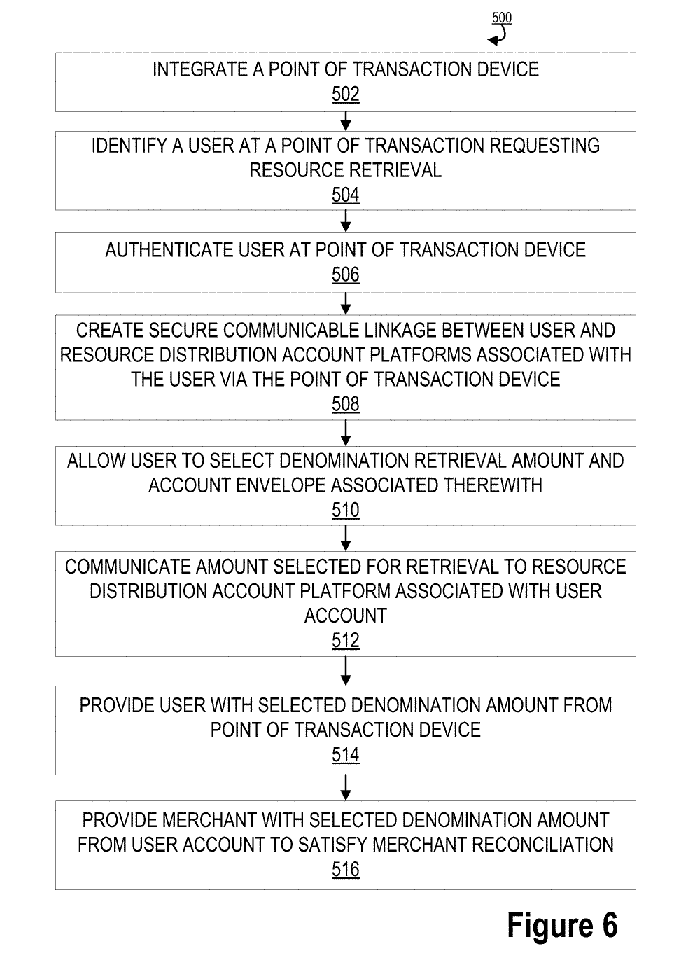

FIG. 6 illustrates a process of resource distribution using the third party system integrated resource distribution channel 500, in accordance with embodiments of the present invention. As illustrated in block 502, the process 500 is initiated by integrating a point of transaction device. In this way, the system integrates within a computer terminal, such as a third party point of transaction device or the like providing software and/or hardware for performing the functions of creating a resource distribution channel authorization through the third party system. As such, the system interlinks within a third party point of transaction device for resource distribution channel authorization through the device.

Next, as illustrated in block 504, the process 500 continues by identifying a user at a point of transaction, where the user is requesting resource retrieval. The user may be identified based on a request for authentication. In this way, the user device may communicate with the point of transaction device via near field communication or the like. Furthermore, in some embodiments, the point of transaction device may communication with the resource distribution account platform. In some embodiments, the user device may communication with the resource distribution account platform. In some embodiments, both the user device and the point of transaction device may communication with the resource distribution account platform.

Furthermore, the user may provide a debit or credit card at the point of transaction device and provide additional authorization such as a pin number or the like. This authorization may trigger the resource distribution channel and communication linkage between the resource distribution account platform, the user device, and the point of transaction. In some embodiments, the resource distribution account platform may be the processing system and/or authentication database.

As illustrated in block 506, the user may be authenticated at the point of transaction device. In some embodiments, this authentication may be through user device interaction with the point of transaction device. In some embodiments, the authentication may be through user swiping of a debit or credit card at the point of transaction device. Furthermore, an additional secondary authentication may be required, such as a pin number, password, or the like by the user to trigger the resource distribution channel authorization at the third party point of transaction device.

Next, as illustrated in block 508, the process 500 continues by creating the secure communicable linkage between the user and the resource distribution account platforms associated with the user accounts via the point of transaction device. In this way, the user device may communicate with the point of transaction device via near field communication or the like. Furthermore, in some embodiments, the point of transaction device may communication with the resource distribution account platform. In some embodiments, the user device may communication with the resource distribution account platform. In some embodiments, both the user device and the point of transaction device may communication with the resource distribution account platform. As such, the system generates secure communication linkage for direct linkage to resource distribution account platforms associated with the user authorization for the resource retrieval.

As illustrated in block 510, the process 500 continues by allowing the user to select denomination retrieval amount and account envelope associated therewith. In this way, the system may receive a user request for a denominational resource retrieval from the computer terminal at the third party location, such as the point of transaction device. In some embodiments, the user may use his/her user device to input an amount of resources the user requests from the user account. In other embodiments, the user may select the amount of resources the user requests from the user account via the point of transaction device.

In some embodiments, the system may also provide the user with incentives, such as merchant discounts or the like for using the resource distribution channel authorization through the third party. As such, providing the user with a valued proposition for the extraction of funds from the point of transaction device associated with the merchant.

Once the user inputs an amount of resources he/she desires for withdraw from the third party point of transaction device, the process 500 continues by communicating the amount selected for retrieval to the resource distribution account platform associated with the user account, as illustrated in block 512. The platform may confirm that the funds are available and communicate the availability to the point of transaction device. In this way, the system may process the request for the denominational resource retrieval by allowing third party location distribution of resources equal to the request to the user. As such, as illustrated in block 514, the process 500 continues by providing the user with the selected denomination amount from the point of transaction device. In this way, the point of transaction device can provide the user with any denomination, including odd denominations that an ATM or other device cannot provide. The user does not have to complete another transaction with the merchant at the point of transaction.

As illustrated in block 516, the merchant is provided with the selected denomination amount form the user account to satisfy the transaction and provide merchant reconciliation. The system allows a user to access and request denominations of resources at a third party merchant without requiring a purchase at the merchant location. In this way, the system allows for user secure linkage to one or more user accounts when interacting with a merchant computer terminal. As such, the user is able to link to his/her account via a linkage with the merchant third party system in order to perform resource retrieval and distribution including odd denominational resource retrievals that may not be able to be performed at an automated teller machine or the like. Furthermore, the system may parse the user requests for denominations of resources into various envelopes. These envelopes may be digitally associated with the user's account and allow a user to budget or apply resources from the account directly into one or more digital envelopes. For example, the user may allocate resources to these digital envelopes and also withdraw resources directly from the envelopes within a resource distribution account.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. Patent Application | | |
|---|---|---|---|
| Docket Number | Ser. No. | Title | Filed On |
| 7850US1.014033.3029 | To be assigned | MOBILE CELLULAR | Concurrently |
| | | DEVICE TRANSLATION | herewith |
| | | INTO A SECURE CHANNEL | |
| | | IDENTIFIER FOR | |
| | | RESOURCE MANAGEMENT | |
| 7852US1.014033.3030 | To be assigned | CASSETTE SYSTEM FOR | Concurrently |
| | | SECURE RESOURCE | herewith |
| | | DISTRIBUTION | |
| 7853US1.014033.3042 | To be assigned | MACHINE PRESENTED | Concurrently |
| | | TARGETED ODD | herewith |
| | | DENOMINATIONAL | |
| | | RESOURCE DISTRIBUTOR | |
| | | SYSTEM | |

What is claimed is:

1. A system for channel authorization through third party systems, the system comprising:
a memory device with computer-readable program code stored thereon;
a communication device;
a printing device for printing the resource distribution documents;
a processing device operatively coupled to the memory device and the communication device, wherein the processing device is configured to execute the computer-readable program code to:
integrate within a computer terminal at a third party location associated with the third party system, wherein the computer terminal is capable of a distribution of resources;
authorize a user at the computer terminal and receive a request for resource retrieval at the third party location;
generate secure communication linkage for direct linkage to resource distribution account platforms associated with the user authorization for the resource retrieval;
receive user request for a denominational resource retrieval from the computer terminal at the third party location;
process the request for the denominational resource retrieval by allowing third party location distribution of resources equal to the request to the user; and
channel the resources of the request from the resource distribution account platform via the secure communication linkage.

2. The system of claim 1, wherein receiving the user request for denomination resource retrieval from the computer terminal at the third party location further comprises receiving an account and an envelope associated with the account for denominational extraction for the denomination retrieval.

3. The system of claim 1, wherein generating the secure communication linkage for direct linkage to resource distribution account platforms associated with the user authorization further comprises generating a secure linkage between a user device, a point of transaction device, and the resource distribution account platform.

4. The system of claim 1, wherein the computer terminal at the third party location further comprises a point of transaction device at a merchant used for completing a transaction with a merchant.

5. The system of claim 1, wherein resources of the request for denomination resource retrieval are from a user associated account with the resource distribution account platform.

6. The system of claim 1, wherein the request for denomination retrieval request includes an odd denomination amount from a user account.

7. The system of claim 1, wherein authorizing the user at the computer terminal further comprises authorization via user device interaction with the computer terminal via token exchange authorization and passcode acceptance.

8. The system of claim 1, wherein the secure communication linkage further comprises allowing the user to generate and deploy one or more digital envelopes within an account associated with the user at the resource distribution account platforms accessed via the authorization.

9. A computer program product for channel authorization through third party systems with at least one non-transitory computer-readable medium having computer-readable program code portions embodied therein, the computer-readable program code portions comprising:
an executable portion configured for integrating within a computer terminal at a third party location associated with the third party system, wherein the computer terminal is capable of a distribution of resources;
an executable portion configured for authorizing a user at the computer terminal and receive a request for resource retrieval at the third party location;
an executable portion configured for generating secure communication linkage for direct linkage to resource distribution account platforms associated with the user authorization for the resource retrieval;
an executable portion configured for receiving user request for a denominational resource retrieval from the computer terminal at the third party location;
an executable portion configured for processing the request for the denominational resource retrieval by allowing third party location distribution of resources equal to the request to the user; and
an executable portion configured for channeling the resources of the request from the resource distribution account platform via the secure communication linkage.

10. The computer program product of claim 9, wherein receiving the user request for denomination resource retrieval from the computer terminal at the third party location further comprises receiving an account and an envelope associated with the account for denominational extraction for the denomination retrieval.

11. The computer program product of claim 9, wherein generating the secure communication linkage for direct linkage to resource distribution account platforms associated with the user authorization further comprises generating a secure linkage between a user device, a point of transaction device, and the resource distribution account platform.

12. The computer program product of claim 9, wherein the computer terminal at the third party location further comprises a point of transaction device at a merchant used for completing a transaction with a merchant.

13. The computer program product of claim 9, wherein resources of the request for denomination resource retrieval are from a user associated account with the resource distribution account platform.

14. The computer program product of claim 9, wherein the request for denomination retrieval request includes an odd denomination amount from a user account.

15. The computer program product of claim 9, wherein authorizing the user at the computer terminal further comprises authorization via user device interaction with the computer terminal via token exchange authorization and passcode acceptance.

16. The computer program product of claim 9, wherein the secure communication linkage further comprises allowing the user to generate and deploy one or more digital envelopes within an account associated with the user at the resource distribution account platforms accessed via the authorization.

17. A computer-implemented method for channel authorization through third party systems, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
integrating within a computer terminal at a third party location associated with the third party system, wherein the computer terminal is capable of a distribution of resources;
authorizing a user at the computer terminal and receive a request for resource retrieval at the third party location;
generating secure communication linkage for direct linkage to resource distribution account platforms associated with the user authorization for the resource retrieval;
receiving user request for a denominational resource retrieval from the computer terminal at the third party location;
processing the request for the denominational resource retrieval by allowing third party location distribution of resources equal to the request to the user; and
channeling the resources of the request from the resource distribution account platform via the secure communication linkage.

18. The computer-implemented method of claim 17, wherein receiving the user request for denomination resource retrieval from the computer terminal at the third party location further comprises receiving an account and an envelope associated with the account for denominational extraction for the denomination retrieval.

19. The computer-implemented method of claim 17, wherein generating the secure communication linkage for direct linkage to resource distribution account platforms associated with the user authorization further comprises generating a secure linkage between a user device, a point of transaction device, and the resource distribution account platform.

20. The computer-implemented method of claim 17, wherein the secure communication linkage further comprises allowing the user to generate and deploy one or more digital envelopes within an account associated with the user at the resource distribution account platforms accessed via the authorization.
